(19) United States
(12) Patent Application Publication
(10) Pub. No.: US 2009/0283574 A1
(43) Pub. Date: Nov. 19, 2009

(54) SOLDER BALL MOUNTING APPARATUS AND WIRING BOARD MANUFACTURING METHOD

(76) Inventors: Ryuichi OKAZAKI, Mizunami-shi (JP); Ryosuke Kumagai, Nagoya-shi (JP); Takuya Hando, Inuyama-shi (JP); Hajime Okamoto, Komaki-shi (JP); Motonobu Kurahashi, Kounan-shi (JP)

Correspondence Address: STITES & HARBISON PLLC, 1199 NORTH FAIRFAX STREET, SUITE 900, ALEXANDRIA, VA, 22314, US

(21) Appl. No.: 12/437,998

(22) Filed: May 8, 2009

(30) Foreign Application Priority Data
May 9, 2008 (JP) P2008-123346

(51) Int. Cl. B23K 1/20; B23K 3/06

(52) U.S. Cl. 228/203; 228/41

(57) ABSTRACT

A wiring board includes an insulating layer having a plurality of through holes formed therein, a base substrate layer positioned below the insulating layer, and a plurality of electrodes disposed on the base substrate layer, each electrode having an exposed surface exposed from a respective through hole, each exposed surfaces being coated with a flux. A plurality of solder balls are disposed on the fluxes in the through holes, respectively. An apparatus for mounting the solder balls on the plurality of electrodes includes: a solder ball removing unit configured to remove a first plurality of solder balls located other than in the through holes; and a solder ball pressing unit configured to press a second plurality of solder balls individually disposed in the through holes towards respective electrodes and into respective flux.

### CROSS-REFERENCE TO RELATED APPLICATIONS

This application is based on and claims priority to Japanese patent Application No. 2008-123346 filed May 9, 2008, the above application incorporated herein by reference in its entirety.

### BACKGROUND OF THE INVENTION

1. Field of the Invention

The present invention relates to a solder ball mounting apparatus for mounting solder balls on a wiring board and a method for manufacturing a wiring board in which solder bumps are formed on electrodes.

2. Description of Related Art

A wiring board for mounting electronic components, such as LSI or IC chips, generally includes an insulating layer provided on an outer surface of a base substrate having a wiring pattern of the wiring board. Some types of wiring boards include solder bumps formed on outer surfaces of electrodes (pads) which are exposed from the insulating layer. Solder bumps are formed by disposing solder balls on a flux coated on surfaces of electrodes on the wiring board and performing a reflow process. The method for forming solder bumps is disclosed, for example, in JP-A-2006-074002, JP-A-2006-074001, JP-A-2006-074000, JP-A-2006-073999, JP-A-2000-077837, JP-A-11-289156, JP-A-11-289155, and JP-A-8-316619.

Some of the solder balls disposed on the electrodes may become dislocated from the electrodes, which results in electrodes without solder bumps. Despite the existence of such problems, the above-described patent documents do not provide a solution for sufficiently overcoming the dislocation of solder balls from the electrodes during the wiring board manufacturing process.

### BRIEF SUMMARY OF THE INVENTION

The present invention was made in consideration of the above circumstances, and an object thereof is to provide a solder ball mounting apparatus capable of suppressing defects caused by solder balls that have fallen out of or otherwise been dislocated from a wiring board and a method for manufacturing a wiring board capable of reducing the connection failures caused by the missing or out of place solder balls.

The invention has been made with a view to solving at least part of the problem described above, and the invention can be realized by the following forms or application examples.

According to one aspect of the invention, a wiring board (i.e., a wiring board assembly), comprises an insulating layer in which a plurality of through holes are formed, a base substrate layer positioned below the insulating layer, and a plurality of electrodes disposed on the base substrate layer, each electrode having an exposed surface exposed through a respective through hole, each exposed surface being coated with a flux. A plurality of solder balls are disposed on the wiring board such that some of the solder balls are individually disposed on the fluxes in the plurality of through holes. A solder ball mounting apparatus for mounting the solder balls on the plurality of electrodes comprises: a solder ball removing unit for removing from the wiring board a first plurality of solder balls disposed other than in the plurality of through holes (i.e., extra solder balls), and a solder ball pressing unit for pressing a second plurality of solder balls disposed in the plurality of through holes (i.e., regularly disposed solder balls) towards respective electrodes and into respective flux.

According to this aspect of the solder ball mounting apparatus, when the plurality of solder balls are disposed on the fluxes, the extra solder balls can be removed, and regularly disposed solder balls can be more securely adhered to the flux and the electrodes. Consequently, the instance of missing solder balls caused by the regularly disposed solder balls falling out of or being dislocated from the wiring board, and the occurrence of defective wiring boards caused by missing or out of place solder balls, is reduced.

For the purpose of this description, “solder” is not particularly limited in terms of materials thereof. That is, any material can be used as long as it has conductive properties. For example, the solder may contain materials including gold, silver, platinum, copper, aluminum, tin, nickel, palladium, molybdenum, niobium, and alloys thereof.

Further, for the purpose of this description, a “ball” does not have to be a true sphere, and hence, oval, cylindrical, hexahedral and polyhedral shapes may be adopted.

According to one implementation, a mask is disposed on an outer surface of the insulating layer and the solder ball pressing unit includes a sliding member which slides on an outer surface of the mask. The mask has a plurality of communication holes which are in communication with the through holes of the insulating layer, respectively. The sliding portion presses the second plurality of solder balls (i.e., the regularly disposed solder balls) towards the respective electrode and into the flux.

Thus, the regularly disposed solder balls are pressed by the sliding member, and the adhesion between the flux, the electrodes, and the regularly disposed solder balls is easily enhanced. In addition, the solder ball mask protects the insulating layer from the brushing action of the sliding member.

The sliding member may be a first brush. Irrespective of spaces between any convex portions and any degrees of protrusion thereof from the brushing surface, since the bristles of the brush contact the respective regularly disposed solder balls, the regularly disposed solder balls are easily pressed toward the respective electrodes and into the flux.

According to another implementation, the solder ball removing unit includes a plurality of second brushes which slide on the outer surface of the solder ball mask. The extra solder balls are removed from the outer surface of the solder ball mask by the sliding action of the solder ball removing unit, whereby the unnecessary adhesion of solder to unexpected parts on the wiring board is prevented, and a defect such as occurrence of short circuit between terminals is decreased or eliminated.

According to yet another implementation, the solder ball pressing unit is made of a conductive member. Thus, the generation of static electricity by the siding action of the solder ball pressing unit is decreased. Consequently reducing the occurrence of a defect in which the regularly disposed solder balls are not disposed in the normal positions or fall therefrom due to the static electricity which causes the regularly disposed solder balls to be absorbed into the solder ball pressing unit.

In accordance with still yet another implementation, the solder ball pressing unit is integrally formed, or unified, with the solder ball removing unit. Thus, the step of removing the extra solder balls and the step of pressing the regularly disposed solder balls can be executed substantially at the same time. Consequently, the occurrence of manufacturing failures resulted from the dislocation of regularly disposed solder balls can be decreased in the manufacturing process of the wiring board. In the meantime, a defect such as short circuit caused by the extra solder balls is decreased, thereby making it possible to realize a reduction in manufacturing time.

According to another aspect of the invention, a wiring board (i.e., a wiring board assembly), comprises an insulating layer having a plurality of through holes, a base substrate layer positioned below the insulating layer, and a plurality of electrodes disposed on the base substrate layer, each of the plurality of electrodes having an exposed surface exposed through respective through holes. A manufacturing method for the wiring board comprises the steps of: (a) coating a flux on the exposed surface of each of the plurality of electrodes; (b) disposing a plurality of solder balls such that a first plurality of solder balls are disposed other than in the plurality of through holes and a second plurality of solder balls are disposed in the plurality of through holes; (c) removing the first plurality of solder balls (i.e., extra solder ball(s)) disposed other than in the plurality of through holes; and (d) pressing the second plurality of solder balls (i.e., regularly disposed solder balls) disposed in the plurality of through holes towards respective electrodes and into respective flux.

Therefore, the adhesion between the regularly disposed solder balls, the flux, and the electrodes can be increased while removing the extra solder balls. Consequently, the instance of failure of the wiring board caused by missing or dislocated solder balls is decreased.

According to one implementation, step of removing the first plurality of solder balls and the step of pressing the second plurality of solder balls are performed as a part of a single pass of an integral solder ball removing and pressing unit.

According to another implementation, the step of pressing the second plurality of solder balls (i.e., the regularly disposed solder balls) is performed after the step of removing the first plurality of solder balls (i.e., the extra solder balls).

Again, the adhesion between the regularly disposed solder balls, the flux, and the electrodes is increased after having removed the extra solder balls. Consequently, the occurrence of failure of the wiring board caused by missing or dislocated solder balls is decreased.

According to another aspect of the invention, a wiring board (i.e., a wiring board assembly) comprises an insulating layer having a through hole formed therein, a base substrate layer positioned below the insulating layer, and an electrode disposed on the base substrate layer and having an exposed surface exposed through the through hole. The exposed surface of the electrode is coated with a flux. A solder ball is disposed on the flux in the through hole. A solder ball mounting apparatus for mounting solder balls on electrodes provided in the wiring board, such as described above, comprises: a solder ball removing unit configured to remove a first solder ball located other than in the through hole; and a solder ball pressing unit configured to press a second solder ball located in the through hole toward the electrode and into the flux.

In accordance with one implementation, the solder ball mounting apparatus further includes a mask disposed on the insulating layer, the mask having an outer surface and a communication hole, the communication hole being in communication with the through hole of the insulating layer. In this implementation, the solder ball pressing unit comprises a sliding member which slides on the outer surface of the mask, and presses the second solder ball toward the electrode. The sliding member may be a first brush which slidingly brushes the outer surface of the mask.

In addition, the invention can be realized by various forms. For example, the invention can be realized in the form of a solder ball mounting apparatus, a wiring board manufacturing method, a wiring board manufacturing apparatus which includes the function of the solder ball mounting apparatus or executes the wiring board manufacturing method, a computer program for controlling the wiring board manufacturing apparatus, or a tangible computer readable medium (i.e., a computer readable medium product) having the computer program stored thereon.

Other features and advantages of the invention will be set forth in, or apparent from, the detailed description of the exemplary embodiments of the invention found below.

### BRIEF DESCRIPTION OF THE DRAWINGS

FIGS. 1A and 1B are plan views of an exemplary wiring board manufactured by an exemplary manufacturing process according to the invention;

FIGS. 2A and 2B are schematic diagrams showing the wiring board in use and illustrating mounting an electronic component on the wiring board;

FIG. 3 is a flowchart showing steps of an exemplary solder bump forming process;

FIGS. 4A to 4C are diagrams illustrating a flux coating mask placing step and a flux coating step;

FIGS. 5A and 5B are diagrams illustrating a solder ball mask placing step;

FIGS. 6A and 6B are diagrams illustrating a solder ball disposing step;

FIGS. 7A and 7B are schematic diagrams showing a solder ball removing unit;

FIGS. 8A and 8B are diagrams illustrating a step of removing extra solder balls by the solder ball removing unit and a step of pressing regularly disposed solder balls, respectively; and

FIGS. 9A and 9B are a diagram illustrating a solder ball mask removing step and a schematic diagram illustrating solder bumps formed by a reflow technique.

### DETAILED DESCRIPTION OF EXEMPLARY EMBODIMENTS OF THE INVENTION

A. Exemplary Embodiment:

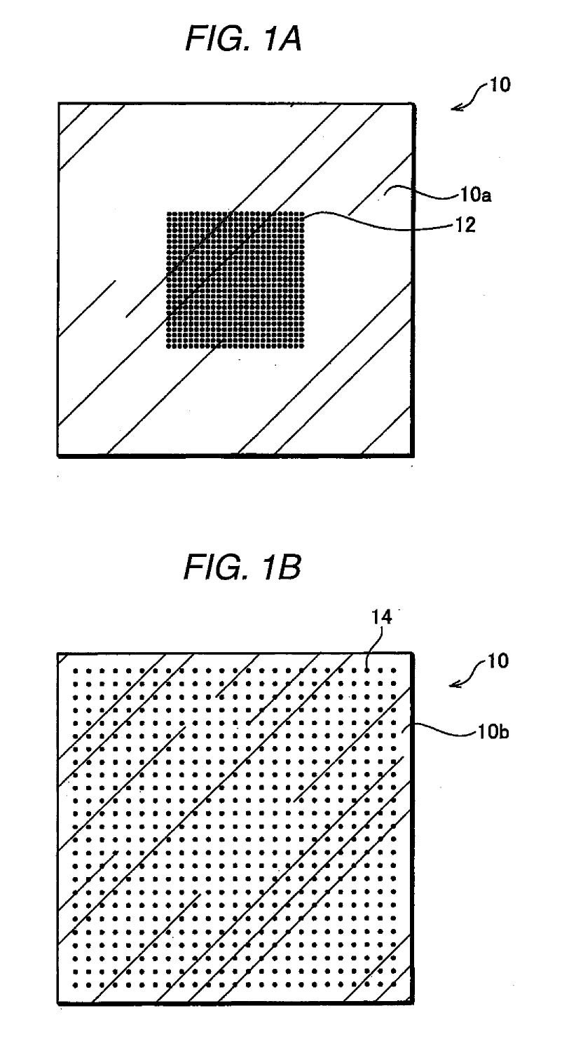

FIGS. 1A and 1B are opposing plane views of an exemplary wiring board 10 that is to be manufactured by a manufacturing process according to an exemplary embodiment of the invention. FIG. 1A shows a first surface 10a of the wiring board 10, and FIG. 1B shows a second surface 10b of the wiring board 10 which is opposite to the first surface 10a. This wiring board 10 is a substantially square substrate board and has a multi-layer structure in which a base substrate (not shown) having a wiring layer formed by copper plating is sandwiched by insulating layers of a synthetic resin.

The first surface 10a of the wiring board 10 has a plurality of first terminal connecting portions 12 formed thereon provided for contacts to terminals of an electronic component such as an LSI or IC chip. The first terminal connecting portions 12 are arranged in a substantially square area in a center portion of the first surface 10a so as to form a grid array in which the first terminal connecting portions 12 are spaced from one another at equal intervals. The second surface 10b of the wiring board 10 has second terminal connecting portions 14 formed thereon. The second terminal connecting portions 14 are arranged in a substantially square area of the second surface 10b so as to form a grid array in which the second terminal connecting portions 14 are spaced from one another at equal intervals. The intervals of the second terminal connection portions 14 are lager than the intervals of the first terminal connecting portions 12. The second terminal connection portions 14 are electrically connected to the respective first terminal connecting portions 12 via respective wiring patterns of the wiring board 10.

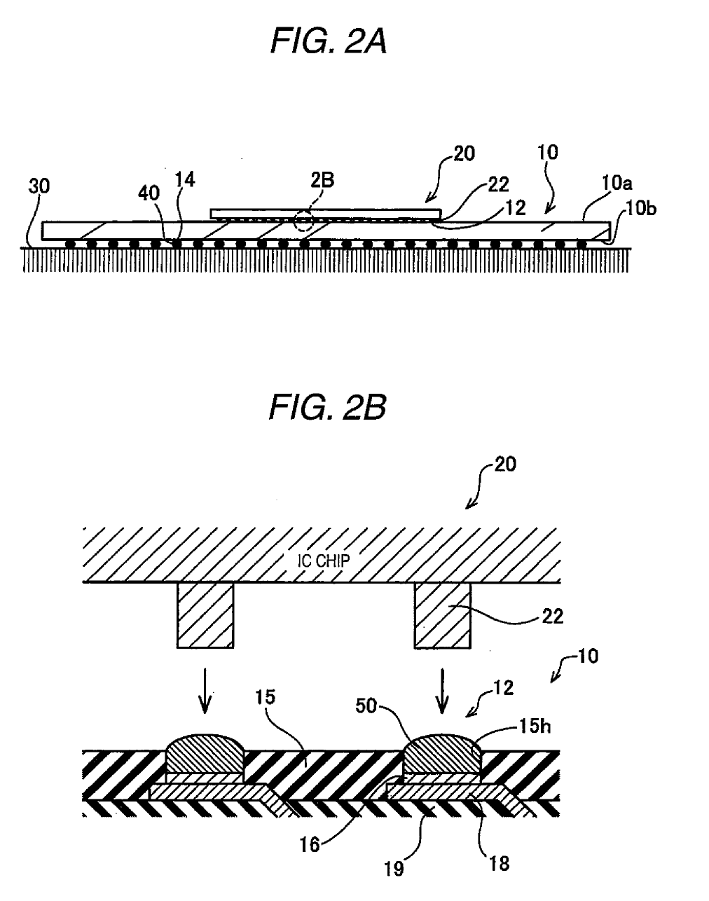

FIG. 2A is an elevational view of the wiring board 10 in use. An electronic component 20 (an IC chip or die) is mounted on the first surface 10a of the wiring board 10. The electronic component 20 includes a plurality of terminals 22 protruding in a thickness direction of the electronic component 20, and the terminals 22 are connected to the respective first terminal connecting portions 12 of the wiring board 10. The second terminal connecting portions 14 are connected to a printed wiring board 30 via respective external terminals 40 such as solder balls or a lead frames. In this way, the wiring board 10 functions as a connector for electrically connecting the electronic component 20 with the printed wiring board 30. The wiring board 10 may have a property for enhancing heat radiation of the electronic component 20.

FIG. 2B is a schematic sectional view illustrating a method for mounting the electronic component 20 on the wiring board 10. FIG. 2B shows a portion of the wiring board 10 which is circled by a broken line 2B in FIG. 2A. The wiring board 10 includes: an insulating layer (a solder resist layer) 15 having a surface as an outer surface of the wiring board 10; and a base substrate 19 disposed or positioned below the insulating layer 15 and including wiring leads 18 which are a part of the wiring layers of the wiring board 10.

A plurality of through holes 15h are provided in the insulating layer 15 for forming the first terminal connecting portions 12. An electrode 16 (also referred to as a pad) and a solder bump 50 are disposed in each of the through holes 15h. The electrode 16 and the solder bump 50 comprise the first terminal connecting portion 12. Specifically, the wiring 18 extends to the through hole 15h, and the electrode 16 is disposed on the extended portion of the wiring 18 such that an outer surface of the electrode 16 is exposed from the through hole 15h. The solder bump 50 is formed on the outer surface of the electrode 16. The through hole 15h is filled with thee solder bump 50. The solder bump 50 protrudes from an outer surface of the insulating layer 15. The electronic component 20 is mounted on the wiring board 10 such that solder bumps 50 contact the respective terminals 22 of the electronic component 20, and is soldered to the wiring board 10 through a reflow step.

The solder bump 50 may be formed by mounting a solder ball on a flux coated on an electrode 16 and thereafter heating the solder ball to melt. Consequently, in the manufacturing process of a wiring board, solder balls have to be accurately (completely) mounted on the electrodes and the flux. However, since the solder balls are minute balls, for example, with a diameter of 150 μm or smaller, the solder balls may become dislocated or fall out of the through holes 15h in the mounting step thereof, a transporting step of the wiring board, a reflow step, or a flux cleaning step. In this exemplary embodiment, the dislocation of solder balls is decreased by the use of a solder ball mounting apparatus (which will be described later) for mounting solder balls on a wiring board, whereby solder bumps are appropriately formed on the electrodes of the wiring board. Hereinafter, a process of forming solder bumps will be described.

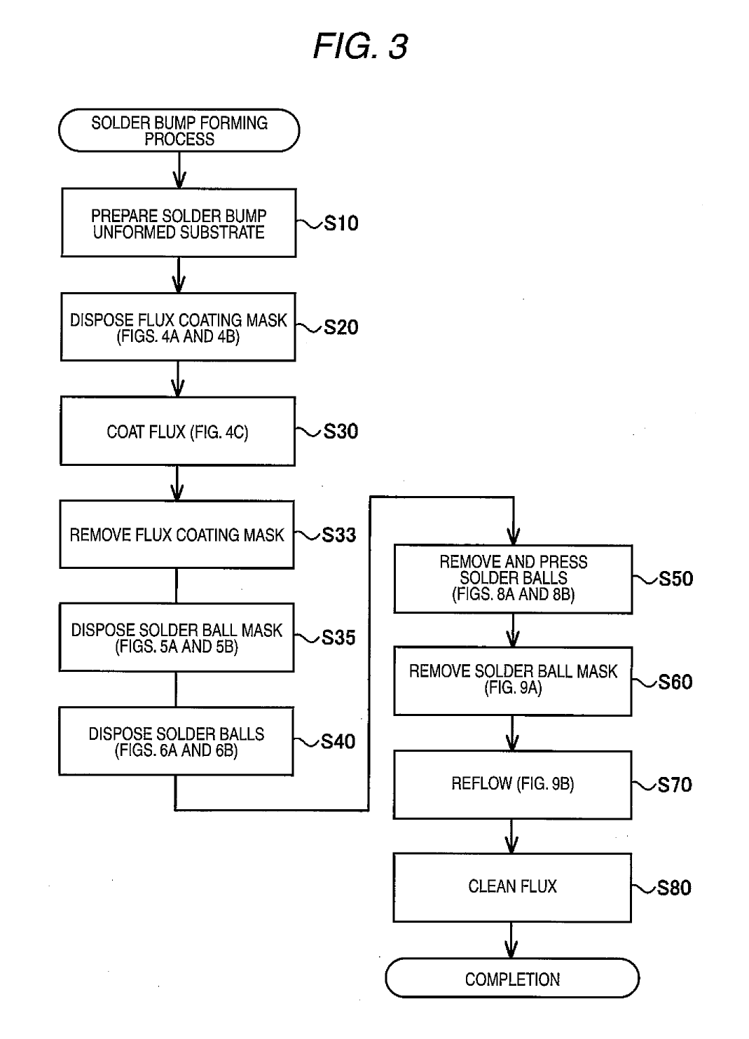

FIG. 3 is a flowchart illustrating sequential steps of a process for forming solder bumps on a wiring board 10. In step S10, a wiring board 10 is prepared on which a solder bump 50 has not yet been formed (hereinafter, referred to as a “solder bump unformed substrate 10p”). That is, the solder bump unformed substrate 10p is the wiring board 10 shown in FIG. 2B without the solder bumps 50.

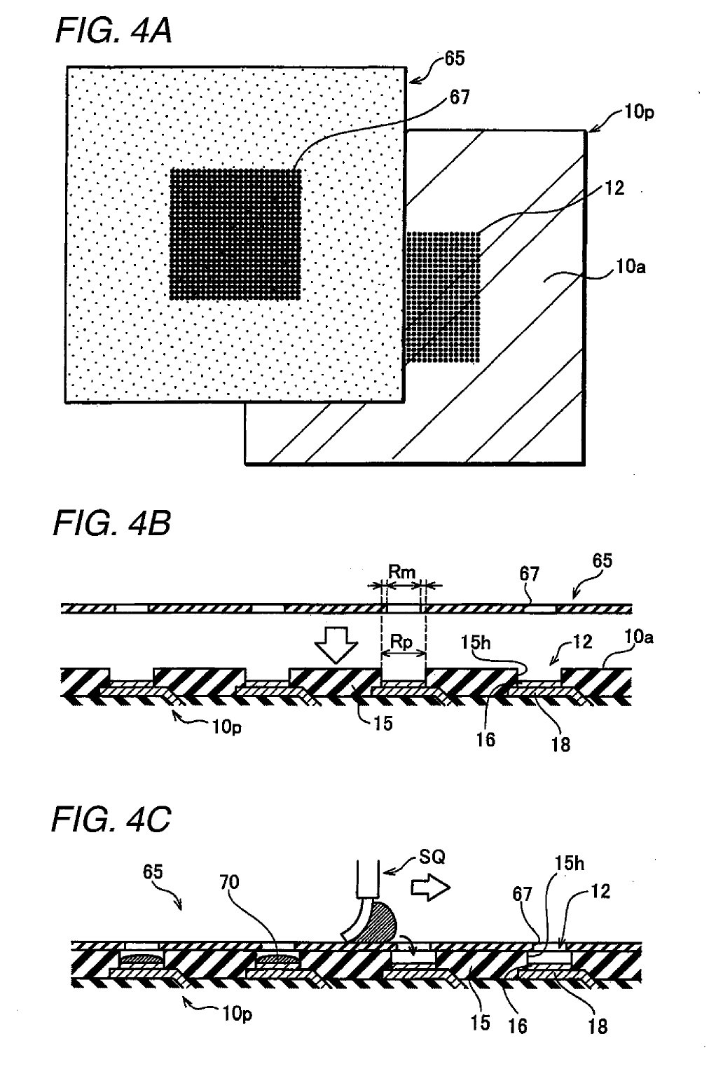

FIGS. 4A and 4B are exemplary diagrams used in illustrating step S20, disposing a flux coating mask. FIG. 4A is a front view similar to FIG. 1A which shows the solder bump unformed substrate 10p and a flux coating mask 65. FIG. 4B shows a step of setting the flux coating mask 65 on the solder bump unformed substrate 10p and shows an enlarged sectional view of an arbitrary portion of the flux coating mask 65 and the solder bump unformed substrate 10p where first terminal connecting portions 12 are formed. In this step, the flux coating mask 65 for coating a flux only on electrode portions of the solder bump unformed substrate 10p is set on the first surface 10a of the solder bump unformed substrate 10p. The flux coating mask 65 is formed of a conductive sheet having substantially the same size as the solder bump unformed substrate 10p, and having flux insertion openings 67 penetrating the flux coating mask 65 so as to correspond to the through holes 15h of the insulating layer 15, respectively. Each of the flux insertion openings 67 are in communication with a respective one of the through holes 15 when the flux coating mask 65 is set on the solder bump unformed substrate 10p. In order to decrease the adhesion of extra flux to the insulating layer 15, a diameter Rm of the flux insertion opening 67 is preferably made smaller than a diameter Rp of the electrode 16.

FIG. 4C is a diagram illustrating step S30 (FIG. 3), coating flux, which shows a schematic sectional view (similar to FIG. 4B) of the solder bump unformed substrate 10p on which the flux coating mask 65 is set. In this step, by sliding a rubber squeegee SQ on an outer surface of the flux coating mask 65, a gelled flux 70 flows into the through holes 15h via the respective flux insertion openings 67, so that the outer surfaces of the electrodes 16 are coated with the flux 70. After it has been inspected that all the electrodes 16 are coated with the flux 70, the flux coating mask 65 is removed from the solder bump unformed substrate 10p (step S33 in FIG. 3).

In this specification, an apparatus for executing a series of steps from step S35 to step S60, which will be described below, will be referred to as a “solder ball mounting apparatus.” The solder ball mounting apparatus includes a solder ball removing unit 100 which is used in step S50, a mechanism for spraying solder balls 80 which is used in step S40, and a working table on which the solder bump unformed substrate lOp is disposed throughout the series of steps.

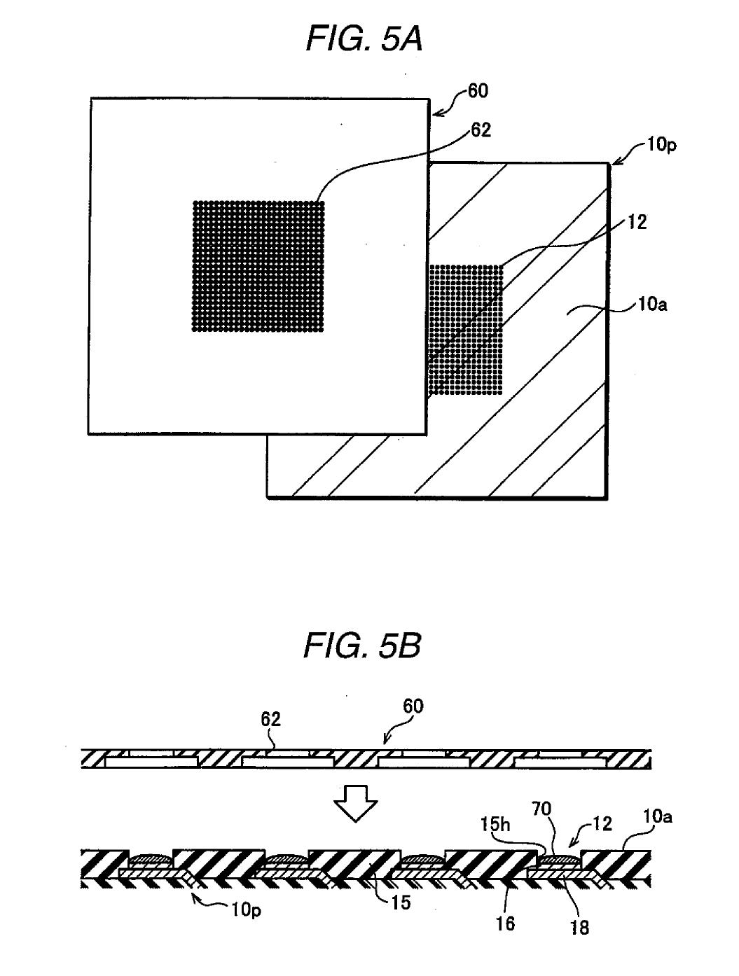

FIGS. 5A and 5B are diagrams used in illustrating step S35, disposing a mask for solder balls. FIGS. 5A and 5B are similar to FIGS. 4A and 4B except that the flux coating mask 65 is replaced with a solder ball mask 60. In this step, the solder ball mask 60 is set on the first surface 10a of the solder ball unformed substrate 10p for protecting the insulating layer 15 of the solder bump unformed substrate 10p. The solder ball mask 60 is an insulating sheet having a size substantially the same as that of the solder bump unformed substrate 10p, and has a plurality of communication holes 62 corresponding to the through holes 15h of the insulating layer 15, respectively. When the solder ball mask 60 is set on the solder bump unformed substrate 10p, the communication holes 62 are in communication with the respective through holes 15h. Herein, the solder bump unformed substrate 10p on which the solder ball mask 60 is set will be referred to as a “mask placed substrate 10m.”

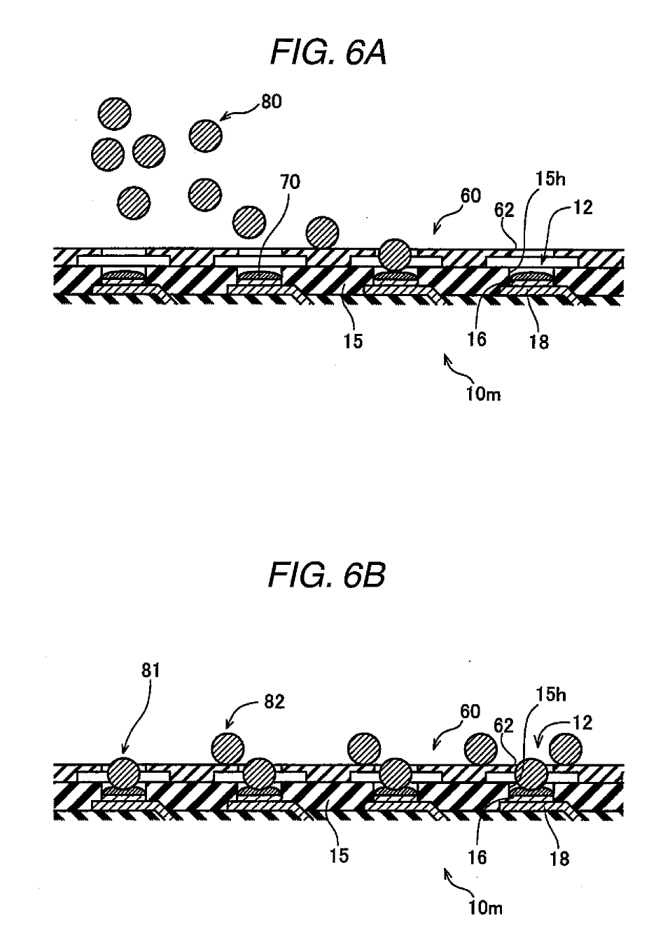

FIGS. 6A and 6B are diagrams illustrating step S40 (FIG. 3), disposing solder balls. FIGS. 6A and 6B show the mask placed substrate 10m in similar schematic sectional views to FIG. 4C. In this step, a number of solder balls 80 larger than the number of the electrodes 16 are sprayed on an outer surface of the solder ball mask 60 (FIG. 6A), so that one solder ball 80 can be disposed on the flux 70 on each of the electrodes 16. Herein, of the solder balls 80 so sprayed, a second plurality of solder balls that fall into the through holes 15 and the communication holes 62 to thereby be disposed on the flux 70 will be referred to as “regularly disposed solder balls 81.” In addition, a first plurality of solder balls not disposed on the flux 70 but overflowed on the outer surface of the solder ball mask 60 will be referred to as “extra solder balls 82.”

In a state immediately after the solder ball mounting step (step S40) has been completed, the regularly disposed solder balls 81 are simply disposed on the flux 70 but do not sufficiently contact the electrodes 16. Thus, in a reflow (heating) step corresponding to step S70, the electrodes 16 and the regularly disposed solder balls 81 may not be in direct, metal-to-metal contact, which may cause the regularly disposed solder balls 81 to fall out of the through holes 15h in subsequent steps (from step 80 and subsequent steps thereof). In particular, in a case where the diameter of the regularly disposed solder balls 81 is small, for example, 80 μm or smaller, since a downward force resulting from their own weight is small, the regularly disposed solder balls 81 do not contact the electrodes 16 sufficiently, and hence, they cannot be metallicly joined together during reflow in step S70. Therefore, the regularly disposed solder balls 81 are likely to fall in step 80 of a flux cleaning step, and subsequent steps. Further, when air bubbles are generated in the flux 70, the air bubbles may expand and break during the reflowing step (step S70), which may expel the regularly disposed solder balls 81 from the flux 70.

In order to avoid the disadvantages described above, in the following step S50 (FIG. 3), the extra solder balls 82 located on the solder ball mask 60 are removed, and the regularly disposed solder balls 81 are pushed towards the electrodes 16 and into the flux. Consequently, the electrodes 16 and the regularly disposed solder balls 81 are in direct contact so as to increase the adhesion between the flux 70 and the regularly disposed solder balls 81.

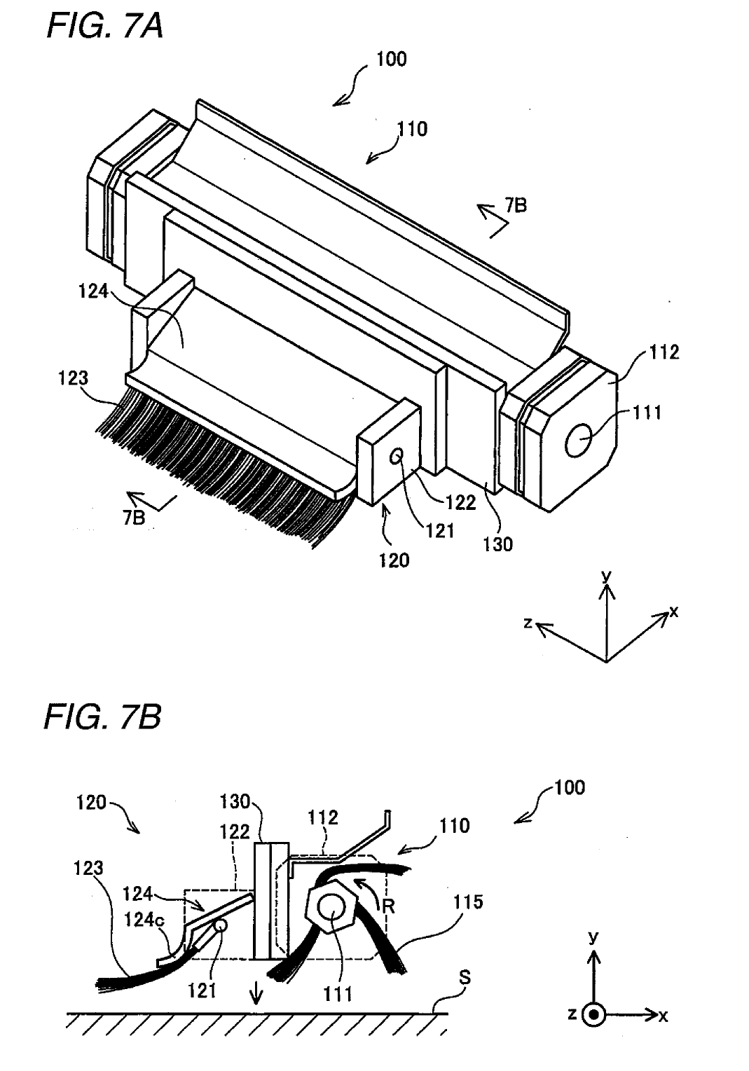

FIGS. 7A and 7B are schematic diagrams showing a solder ball removing unit 100, which is used in step S50. FIG. 7A is a schematic perspective view of the solder ball removing unit 100, and FIG. 7B is a schematic sectional view of the solder ball removing unit 100 taken along the line 7B-7B shown in FIG. 7A. The solder ball removing unit 100 includes: a solder ball removing portion 110 for removing the extra solder balls 82; and a solder ball pressing portion 120 for pressing the regularly disposed solder balls 81 toward the electrodes. The solder ball removing portion 110 may also press the regularly disposed solder balls 81 toward the electrodes. The solder ball removing unit 100 further includes a plate-shaped support base member 130 having longer sides extending along a Z axis direction as viewed in the drawing. The solder ball removing portion 110 is provided on one side of the support base member 130, and the solder ball pressing portion 120 is provided on the other side of the support base member 130.

The solder ball removing portion 110 includes: a rotational drive shaft 111 having an axis extending in the Z axis direction; and drive portions 112 fixed to two shorter sides of the support base member, respectively. Both end portions of the rotational drive shaft 111 in the axial direction are rotatably held and driven by drive portions 112. A plurality of removing brushes 115 are provided on the rotational drive shaft 111 (FIG. 7B). Bristles of each removing brush 115 extend radially outwards from the rotational drive shaft 111. When the rotational drive shaft 111 rotates in a direction indicated by an arrow R, the removing brushes 115 slidingly brush a disposing surface S on which the solder ball removing unit 100 is disposed.

The solder ball pressing portion 120 includes a brush mounting shaft 121 which is held on bearing portions 122 which are fixed to the support base member 130 (FIG. 7A). A pressing brush 123 is attached to the brush mounting shaft 121, and the pressing brush 123 includes bristles obliquely extending towards the disposing surface S so as to slidingly brush the disposing surface S. The solder ball pressing portion 120 further includes a brush pressing portion 124 disposed on the pressing brush 123 for pressing the bristles of the pressing brush 123 towards the disposing surface S. The brush pressing portion 124 is a plate-shaped member having longer sides extending along the Z axis direction and is fixed integrally to the pressing brush 123 by one side thereof joined to the brush mounting shaft 121. The brush pressing portion 124 includes a curved portion 124c, which is curved towards the pressing brush 123, provided on a side of the brush pressing portion 124 which faces the bristles of the pressing brush 123. This curved portion 124c presses the bristles of the pressing brush 123 towards the disposing surface S.

The bristles of the removing brushes 115 and the bristles 125 of the pressing brush 123 are preferably provided over a width wide enough to slidingly brush the outer surface of the solder ball mask 60 at one time. In addition, the brushes 115, 123 are preferably formed of conductive members so as to decrease the generation of static electricity caused by the slidingly brushing actions of the bristles thereof.

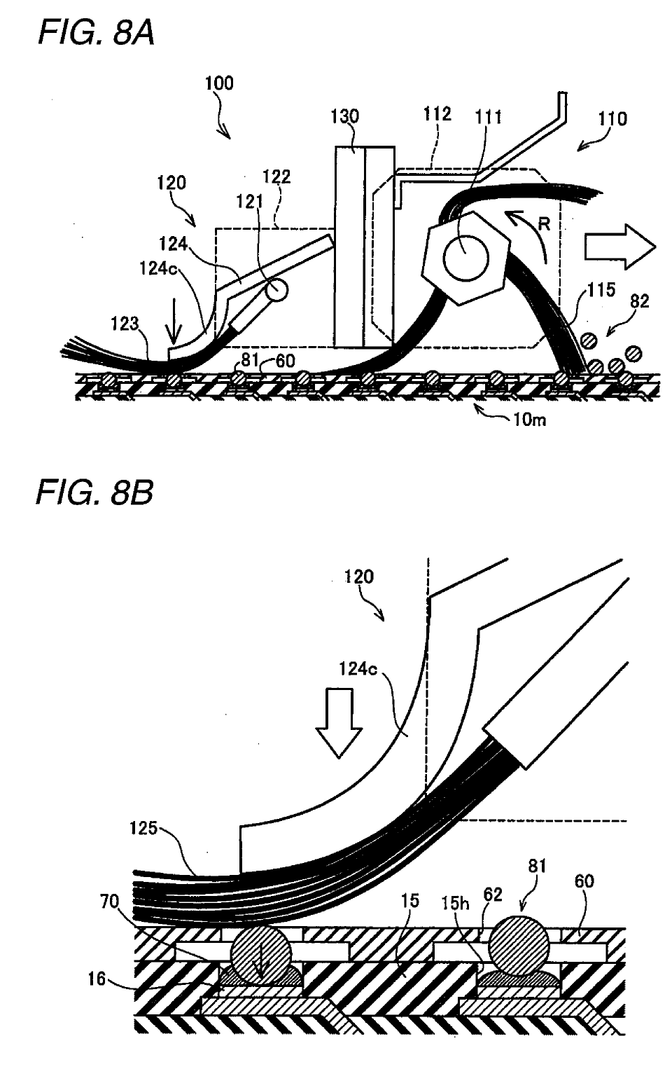

FIGS. 8A and 8B are schematic diagrams which illustrate a state in which the solder ball removing unit 100 is in use. FIG. 8A shows the solder ball removing unit 100 in a similar schematic sectional view to FIG. 7B, in which the mask placed substrate 10m is shown in a similar schematic sectional view to FIG. 6B. FIG. 8B is a enlarged schematic diagram illustrating a part of FIG. 8A so as to explaining the function of the pressing brush 123.

Step S50 (FIG. 3) is removing and pressing solder balls. FIG. 8A shows the solder ball removing unit 100 disposed above the solder ball mask 60 moving in a direction indicated by an arrow while the removing brushes 115 rotate, so as to skim the outer surface of the solder ball mask 60. Consequently, the removing brushes 115 sweep the extra solder balls 82 from the solder ball mask 60 while slidingly brushing the spherical surfaces of the regularly disposed solder balls 81, which are exposed from the outer surface of the solder ball mask 60 through the communication holes 62.

In this exemplary embodiment, the extra solder balls 82 are removed and the regularly disposed solder balls 81 are prevented from being dislocated from the predetermined positions where they are disposed by the slidingly brushing actions of the removing brushes 115. Since the solder ball mask 60 functions as a position fixing supporting member for holding the positions of the regularly disposed solder balls 81, dislocation of the regularly disposed solder balls 81 from the predetermined positions is decreased by the removing brushes 115.

The pressing brush 123 slidingly brushes the spherical surfaces of the regularly disposed solder balls 81 exposed from the communication holes 62 on the outer surface of the solder ball mask 60 while being pressed by the curved portion 124c of the brush pressing portion 124 in a direction towards the electrode 16 (a direction indicated by an arrow) in FIG. 8B. As a result, the regularly disposed balls 81 are pushed into the flux 70 so as to contact the respective electrodes 16, whereby the adhesion of the regularly disposed solder balls 81 to the flux 70 is increased further than before they are pressed by the pressing brush 123. The regularly disposed solder balls 81 are less likely to fall or be dislocated from the normally disposed positions on the respective electrodes 16 in the subsequent steps. In addition, according to the pressing brush 123, since the bristles thereof can contact the regularly disposed solder balls 81 irrespective of spaces between convexes and degree of protrusion thereof on the slidingly brushing surface, the pressing of almost all the regularly disposed solder balls 81 can be implemented relatively easily.

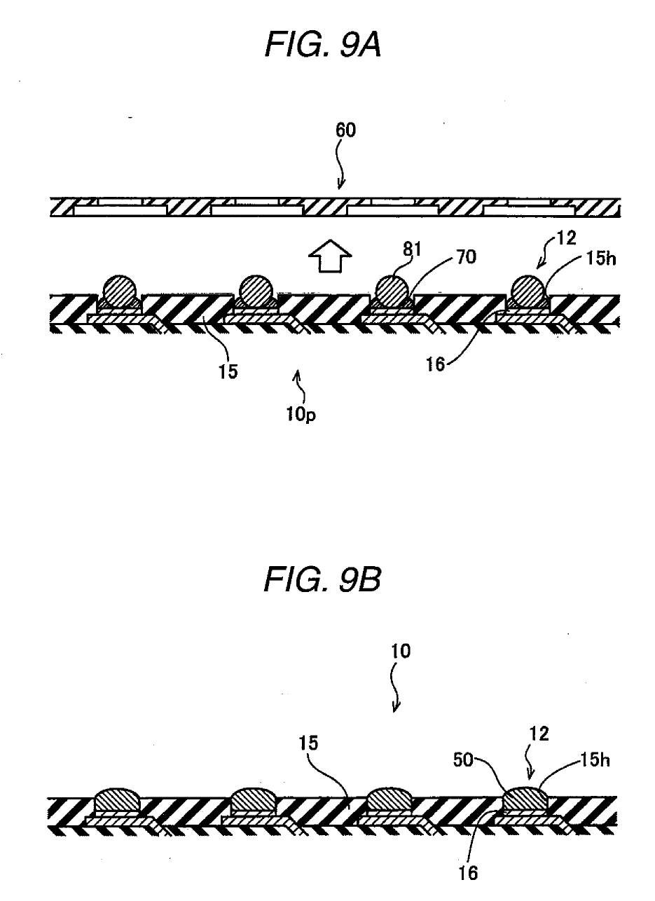

FIG. 9A is a diagram which illustrates a solder ball mask removing step of step S60 (in FIG. 3) and is a schematic sectional view similar to FIG. 8B. In this step S60, the solder ball mask 60 is removed. In addition, since the adhesion between the flux 70 and the regularly disposed solder balls 81 is increased in the previous step, the regularly disposed solder balls 81 are less likely to fall or be dislocated from the disposed positions.

FIG. 9B is a schematic sectional view similar to FIG. 9A and illustrates a wiring board 10 which is a complete product on which solder bumps 50 are formed by heating. In step S70, reflow, the solder bump unformed substrate 10p on which the regularly disposed solder balls 81 are disposed, is heated in a reflow oven. Consequently, the regularly disposed solder balls 81 and the flux 70 are caused to melt and are then solidified, whereby solder bumps 50 are formed. Also in this step (the reflowing step), due to the gain in adhesion between the flux 70 and the regularly disposed solder balls 81 in step S50, dislocation of the regularly disposed solder balls 81 from the disposed positions caused by the bursting of air bubbles within the flux 70 is decreased. Although step S80 (FIG. 3) is a flux cleaning step of removing extra flux which adheres to the wiring board 10, since the joining properties of the solder bumps 60 to the electrodes 16 are increased in the step described above, dislocation of the solder bumps 50 is also decreased.

In this way, the solder ball mounting apparatus including the solder ball removing unit 100 is used in the step of mounting the solder balls on the electrodes 16, which can reduce the possibility of the regularly disposed solder balls 81 becoming displaced or dislocated from the disposed positions in the wiring board 10 manufacturing process. Consequently, the occurrence of a failure of a wiring board caused by the dislocation of solder balls thereof is decreased.

B. Modifications

The present invention is not limited to the exemplary embodiment and the mode for carrying out the invention described above, but can be modified into various forms without departing from the spirit and scope of the invention. The invention can be modified as blow, for example.

B1. Modification 1

In the solder ball removing unit 100 in the exemplary embodiment, although the solder ball removing portion 110 sweeps out the extra solder balls 82 by the removing brushes 115 which are driven to rotate, the extra solder balls 82 may be removed by other methods. For example, the solder ball removing portion 110 may blow out the extra solder balls 82 by air jetted under high pressure.

In the solder ball removing unit 100 in the exemplary embodiment, the solder ball pressing portion 120 presses the regularly disposed solder balls 81 towards the electrodes 16 by pressing the pressing brush 123 by the brush pressing portion 124. However, the solder ball pressing portion 120 may press the regularly disposed solder balls 81 towards the electrodes 16 by other methods. For example, the brush pressing portion 124 may be omitted, and the pressing brush 123 may be urged by a spring mechanism so as to press the regularly disposed solder balls 81. In addition, the solder ball pressing portion 120 may press the regularly disposed solder balls 81 by a conductive resin plate or roller in place of the pressing brush 123.

B2. Modification 2

In the solder ball removing unit 100 in the exemplary embodiment, the solder ball removing portion 110 and the solder ball pressing portion 120 are unified, and the extra solder ball 82 removing step and the regularly disposed solder ball 81 pressing step are executed simultaneously (i.e., in parallel). However, the solder ball removing portion 110 and the solder ball pressing portion 120 may be separate from each other. In other words, the extra solder ball 82 removing step by the solder ball removing portion 110 may be implemented first, and thereafter, the regularly disposed solder ball 81 pressing step may be implemented by the solder ball pressing portion 120.

B3. Modification 3

In the exemplary embodiment described above, the brushes 115, 123 are formed of the conductive members but may be formed of a non-conductive member. However, when the brushes 115, 123 are formed of the conductive member, since the generation of static electricity is decreased, it becomes possible to decrease the dislocation of the regularly disposed solder balls 81 from the disposed positions caused by the regularly disposed solder balls 81 being attracted by static electricity.

B4. Modification 4

In the exemplary embodiment, although the solder ball mask 60 is set on the solder bump unformed substrate 10p (step S20 in FIG. 3), the solder ball mask 60 placing step may be omitted. However, since the solder ball mask 60 functions as not only the protection member for protecting the outer surface of the insulating layer 15 but also the position fixing supporting member for decreasing the offset of the regularly disposed solder balls 81 from the disposed positions, the solder ball mask 60 is preferably set on the solder bump unformed substrate 10p.

B5. Other Modifications

One of ordinary skill in the art will recognize that additional steps and configurations are possible without departing from the teachings of the invention. This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

Thus, the scope of the invention should be determined by the appended claims and their legal equivalents, and not by examples given.

What is claimed is:

1. A solder ball mounting apparatus for mounting solder balls on electrodes provided in a wiring board, the wiring board comprising an insulating layer having a plurality of through holes formed therein, a base substrate layer positioned below the insulating layer, and a plurality of electrodes disposed on the base substrate layer, each electrode having an exposed surface exposed through a respective through hole, each exposed surface being coated with a flux, and wherein a plurality of solder balls are individually disposed on the fluxes in the plurality of through holes, said solder ball mounting apparatus comprising:
a solder ball removing unit configured to remove a first plurality of solder balls disposed other than in the plurality of through holes; and
a solder ball pressing unit configured to press a second plurality of solder balls individually disposed in the plurality of through holes towards respective electrodes and into respective flux.

2. The solder ball mounting apparatus according to claim 1,
further comprising a mask disposed on the insulating layer, the mask having an outer surface and a plurality of communication holes that are communication with the through holes of the insulating layer, respectively,
wherein the solder ball pressing unit comprises a sliding member which slides on an outer surface of the mask, and presses the second plurality of solder balls towards the respective electrodes and into respective flux.

3. The solder ball mounting apparatus according to claim 2, wherein the sliding member is a first brush which slidingly brushes the outer surface of the mask.

4. The solder ball mounting apparatus according to claim 2, wherein the solder ball removing unit comprises a plurality of second brushes which slide on the outer surface of the mask.

5. The solder ball mounting apparatus according to claim 2, wherein the solder ball pressing unit further comprises a conductive member.

6. The solder ball mounting apparatus according to claim 1, wherein the solder ball pressing unit is integrally formed with the solder ball removing unit.

7. A method for manufacturing a wiring board comprising an insulating layer having a plurality of through holes formed therein, a base substrate layer positioned below the insulating layer, and a plurality of electrodes disposed on the base substrate layer, each of the plurality of electrodes having an exposed surface exposed through respective through holes, said method comprising the steps of:
(a) coating a flux on the exposed surface of each of the plurality of electrodes;
(b) disposing a plurality of solder balls such that a first plurality of solder balls are disposed other than in the plurality of through holes and a second plurality of solder balls are individually disposed in the plurality of through holes;
(c) removing the first plurality of solder balls disposed other than in the plurality of through holes; and
(d) pressing the second plurality of solder balls disposed in the plurality of through holes towards respective electrodes and into respective flux.

8. The method according to claim 7, wherein said step of removing the first plurality of solder balls and said step of pressing the second plurality of solder balls are performed as a part of a single pass of an integral solder ball removing and pressing unit.

9. The method according to claim 7, wherein said step of pressing the second plurality of solder balls is performed after said step of removing the first plurality of solder balls.

10. A solder ball mounting apparatus for mounting solder balls on electrodes provided in a wiring board, the wiring board comprising an insulating layer having a through hole formed therein, a base substrate layer positioned below the insulating layer, and an electrode disposed on the base substrate layer and having an exposed surface exposed through the through hole, the exposed surface of the electrode being coated with a flux, and wherein a solder ball is disposed on the flux in the through hole, said solder ball mounting apparatus comprising:
a solder ball removing unit configured to remove a first solder ball located other than in the through hole; and
a solder ball pressing unit configured to press a second solder ball located in the through hole toward the electrode and into the flux.

11. The solder ball mounting apparatus according to claim 10,
further comprising a mask disposed on the insulating layer, the mask having an outer surface and a communication hole, the communication hole being in communication with the through hole of the insulating layer,
wherein the solder ball pressing unit comprises a sliding member which slides on the outer surface of the mask, and presses the second solder ball toward the electrode.

12. The solder ball mounting apparatus according to claim 11, wherein the sliding member is a first brush which slidingly brushes the outer surface of the mask.

13. The solder ball mounting apparatus according to claim 11, wherein the solder ball removing unit comprises a plurality of second brushes which slide on the outer surface of the mask.

14. The solder ball mounting apparatus according to claim 11, wherein the solder ball pressing unit further comprises a conductive member.

15. The solder ball mounting apparatus according to claim 10, wherein the solder ball pressing unit is integrally formed with the solder ball removing unit.
